(19) United States
(12) Patent Application Publication
(10) Pub. No.: US 2011/0199447 A1
(43) Pub. Date: Aug. 18, 2011

(54) IMAGE FORMING APPARATUS AND DRYING METHOD USED IN IMAGE FORMING APPARATUS

(75) Inventors: Nobuaki Takahashi, Shizuoka-ken (JP); Satoshi Kinouchi, Tokyo-to (JP); Satoshi Kaiho, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/024,488

(22) Filed: Feb. 10, 2011

Related U.S. Application Data
(60) Provisional application No. 61/305,393, filed on Feb. 17, 2010.

(51) Int. Cl. B41J 2/01

(52) U.S. Cl. 347/102

(57) ABSTRACT

According to one embodiment, an image forming apparatus has an image forming unit, a heat pump, and a blow-out port. The image forming unit forms an image on a medium. The heat pump generates air of a decreased low humidity. The low-humidity air generated by the heat pump is blown from the blow-out port to the medium on which the image is formed by the image forming unit.

### CROSS-REFERENCE TO RELATED APPLICATIONS

This application is based upon and claims the benefit of priority from U.S. Provisional Application No. 61/305,393 filed on Feb. 17, 2010; the entire contents of which are incorporated herein by reference.

### FIELD

Embodiments described herein relate generally to an image forming apparatus and a drying method used in an image forming apparatus.

### BACKGROUND

For example, in an ink jet-type image forming apparatus, if media in which ink is not dried yet are overlapped, contamination of the reverse sides thereof occurs. In addition, in the ink jet-type image forming apparatus, if an ink amount is large, waviness (cockling) of the media easily occurs. Typically, many types of the ink jet-type image forming apparatuses dry ink printed on a medium using a heater. However, if the medium is dried by heating using the heater, there may be a case where moisture balance in the medium is lost and thus the medium may be damaged. For example, in the image forming apparatus that dries the medium using the heater, paper wrinkles or paper shrinkage easily occurs. In addition, the heater consumes a great deal of power.

### BRIEF DESCRIPTION OF THE DRAWINGS

FIG. 1 is a diagram schematically illustrating an example of the configuration of an image forming apparatus.

FIG. 2 is a diagram illustrating an example of the configuration of a carriage belt.

FIG. 3 is a diagram illustrating an example of the configuration of a carrying mechanism.

FIG. 4 is a top view illustrating an example of the configuration of a head portion.

FIG. 5 is a side view illustrating the example of the configuration of the head portion.

FIG. 6 is a block diagram illustrating an example of the configuration of the control system of the image forming apparatus.

FIG. 7 is a flowchart schematically illustrating the workflow of a printing process.

### DETAILED DESCRIPTION

In general, according to one embodiment, an image forming apparatus has an image forming unit, a heat pump, and a blow-out port. The image forming unit forms an image on a medium. The heat pump generates air of a decreased low humidity. The low-humidity air generated by the heat pump is blown from the blow-out port to the medium on which the image is formed by the image forming unit.

Hereinafter, embodiment will be described with reference to the accompanying drawings.

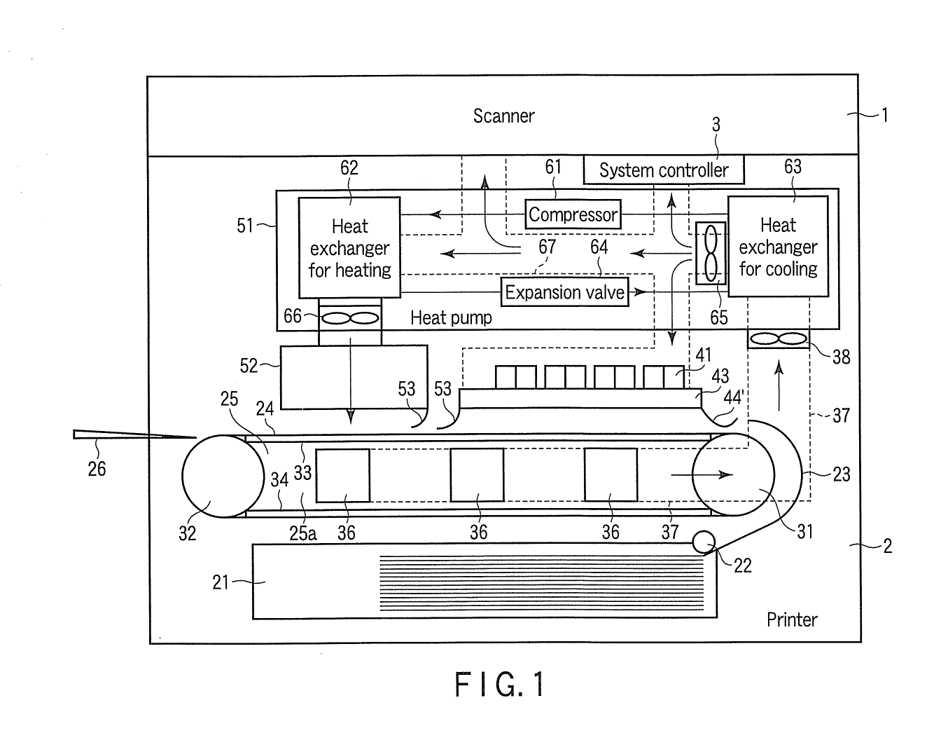

FIG. 1 is a diagram illustrating an example of the configuration of an image forming apparatus.

As illustrated in FIG. 1, the image forming apparatus includes a scanner 1, a printer 2, and a system controller 3.

The scanner 1 is installed at the upper portion of the main body of the image forming apparatus. The scanner 1 is an apparatus that optically scans an image of an original document and converts the image into image data. The scanner 1 includes a control substrate on which a photoelectric conversion unit and the like are mounted, a drive mechanism including a drive motor, and the like. The photoelectric conversion unit converts the image of the original document into the image data. The photoelectric conversion unit is configured by a CCD line sensor or the like that converts an image of an original document surface into image data. The drive mechanism moves a position of the document surface read by the photoelectric conversion unit.

The printer 2 includes a carrying mechanism, an image forming mechanism, and a drying mechanism. The carrying mechanism carries a sheet of paper as an image forming medium. The carrying mechanism takes out the sheet of paper as the image forming medium and carries the sheet of paper taken out to an image forming position and a drying position. The image forming mechanism forms an image on the sheet of paper carried by the carrying mechanism at the image forming position. The image forming mechanism has a head portion that forms an image on a sheet of paper with ink. The drying mechanism dries the sheet of paper carried by the carrying mechanism at the drying position. The drying position is located at the rear end of the image forming position in a carriage direction of the sheet of paper carried by the carrying mechanism. That is, the drying mechanism dries the paper surface on which the image is formed by the image forming mechanism with the ink.

The carrying mechanism includes a cassette 21, a paper feed roller 22, a carriage guide 23, a carriage belt 24, a carriage housing 25, and a paper discharge unit 26. The cassette 21 stores sheets as image forming media on which images are to be printed. The cassette 21 has the paper feed roller 22 at a take-out port of the sheets of paper. The paper feed roller 22 takes out the sheets of paper sheet by sheet from the cassette 21. The paper feed roller 22 carries the sheet of paper taken out from the cassette 21 along the carriage guide 23. The carriage guide 23 guides the sheet of paper taken out by the paper feed roller 22 to the carriage belt 24.

The carriage housing 25 supports the carriage belt 24. The carriage housing 25 has a drive roller 31, a driven roller 32, a top plate 33, a side wall 35, a bottom plate 34, and a fan 36. The carriage belt 24 and the carriage housing 25 carry the sheet of paper taken out from the cassette 21 to the image forming position. The carriage belt 24 and the carriage housing 25 carry the sheet of paper on which an image is formed at the image forming position to the drying position. The carriage belt 24 and the carriage housing 25 carry (discharge) the sheet of paper dried at the drying position to the paper discharge unit 26.

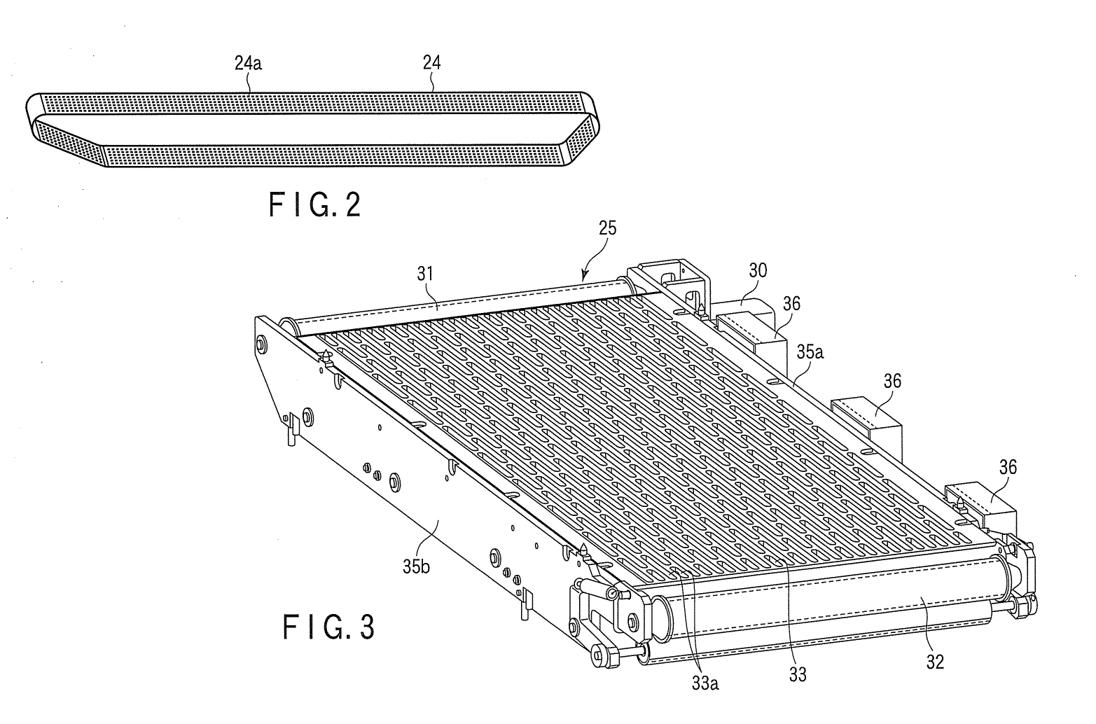

FIG. 2 is a diagram illustrating an example of the configuration of the carriage belt 24. FIG. 3 is a diagram illustrating an example of the configuration of the carriage housing 25.

The carriage belt 24 is a belt made by, for example, laminating rubber on fiber and polishing the surface thereof. The carriage belt 24 has a plurality of holes 24a over the entire surface. The carriage belt 24 is stretched over the drive roller 31 and the driven roller 32 so as to cover the top plate 33 of the carriage housing 25.

The drive roller 31, the driven roller 32, the top plate 33, the bottom plate 34, and the side wall 35 are members that form a space (suction space) 25a. The drive roller 31 and the driven roller 32 in the carriage housing 25 support the carriage belt 24 in a state of applying a predetermined tensile force. The drive roller 31 is rotated by a driving force given by a drive unit such as a motor. The carriage belt 24 is driven by the rotation of the drive roller 31. The driven roller 32 is rotated along the movement of the carriage belt 24 driven by the drive roller 31.

The top plate 33 forms an upper side of the space (suction space) 25a. The top plate 33 is formed in a flat plate shape. The top plate 33 has a number of holes 33a. The top plate 33 supports the carriage belt 24 supported by the drive roller 31 and the driven roller 32 in the flat surface shape. The top plate 33 holds the carriage belt 24 in the flat surface shape at the image forming position. In addition, the top plate 33 is covered by the carriage belt 24 stretched over the drive roller 31 and the driven roller 32. The top plate 33 causes air passing through the holes 24a of the carriage belt 24 by the holes 33a to pass through the suction space 25a. The bottom plate 34 forms the bottom side of the suction space 25a.

The side wall 35 is provided on both sides along end portions in a direction perpendicular to the rotation direction of the carriage belt 24 (35a and 35b). The fan 36 has a function of taking air on the carriage belt 24 in the suction space 25a, and a function of discharging the air taken in the suction space 25a from the suction space 25a.

That is, the fan 36 takes the air on the carriage belt 24 in the suction space 25a via the holes 24a of the carriage belt 24 and the holes 33a of the top plate 33. The fan 36 sucks the air on the carriage belt 24 into the suction space 25a so as to cause the sheet of paper to adsorb onto the carriage belt 24. In addition, the fan 36 discharges the air from the suction space 25a to a duct 37 outside the suction space 25a. The duct 37 is provided with a fan 38. The fan 38 sends the air discharged from the suction space 25a by the fan 36 to a heat pump 51 as the drying mechanism.

The drying mechanism dries the sheet of paper on the carriage belt 24 at the drying position. The air after drying the sheet of paper at the drying position is taken in the suction space 25a via the holes 24a of the carriage belt 24 and the holes 33a of the top plate 33 and is then discharged to the duct 37 from the suction space 25a. The duct 37 is connected to the carriage housing 25 and the heat pump 51. That is, the air after drying the sheet of paper having an image formed thereon is sent to the heat pump 51 via the suction space 25a and the duct 37 by the fans 36 and 37.

Next, the configuration of the image forming mechanism will be described.

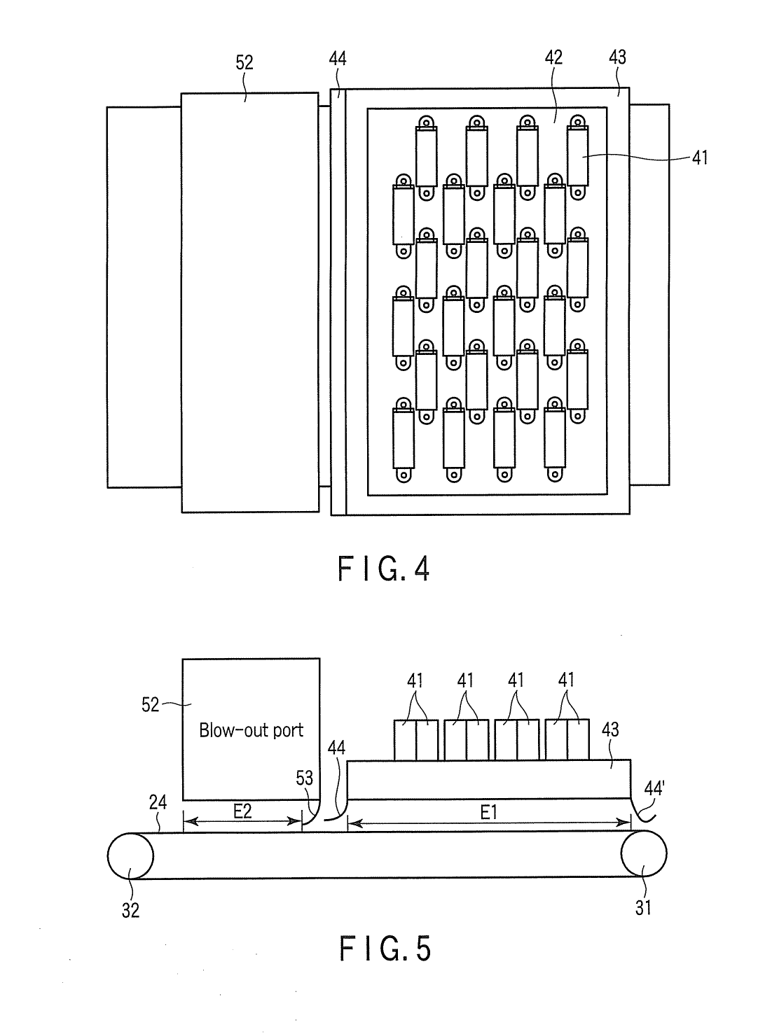

FIG. 4 is a top view illustrating an example of the configuration of the vicinity of a head portion 40. FIG. 5 is a side view schematically illustrating the example of the configuration of the vicinity of the head portion 40.

The head portion (image forming unit) 40 forms an image on the sheet of paper carried by the carriage belt 24 while adsorbing thereon. The head portion 40 has one or a plurality of recording heads 41. The recording head 41 is, for example, an ink jet head. In this embodiment, it is assumed that the recording head 41 is the ink jet head. The recording head 41 is connected to an ink tank and is fixed to a head base 42. For example, the recording head 41 is fixed to the head base 42 so that the position thereof is easily adjusted. The number of recording heads 41 and the installation position thereof are determined depending on an image forming range, a resolution, and the number of colors. The recording head 41 has discharge holes opposed to the paper surface (an image forming surface of the medium) carried on the carriage belt 24 and a discharge mechanism of discharging ink from the discharge holes.

In addition, in the periphery of the recording head 41 and the head base 42 to which the recording head 41 is fixed, a windbreak member 43 is set so as not to cause air to flow to the image forming position (a space from the discharge hole of ink to the paper surface) E1. The windbreak member 43 blocks a gap between the recording head 41 and the head base 42 so as not to cause wind to blow through the gap. The windbreak member 43 is, for example, a sponge. The sponge can be easily processed and thus the shape thereof is easily deformed. The windbreak member 43 can effectively obtain the windbreak effect as long as the windbreak member 43 is deformed depending on the position adjustment of the recording head 41.

Moreover, the head portion 40 has a wind direction plate 44. The wind direction plate 44 adjusts a wind direction so as not to cause air to flow into the image forming position E1 by the recording head 41. In the example of the configuration illustrated in FIGS. 4 and 5, the wind direction plate 44 is set so that air discharged from a blow-out port 52 for drying does not flow to the image forming position E1. The wind direction plate 44 prevents the discharge holes or the like of the recording head 41 from being dried by the air flowing to the image forming position from the periphery. In addition, as illustrated in FIG. 5, a wind direction plate 53 may also be provided in the blow-out port 52. In addition, in the head portion 40, a wind direction plate 44′ may be provided on the upstream side of the carriage direction of the sheets of paper as indicated by the dotted lines of FIG. 5. The blow-out port 52 is disposed on the downstream side of the carriage direction with respect to the head portion 40.

Next, the configuration of the drying mechanism will be described.

The drying mechanism has the heat pump 51, the blow-out port 52, and the wind direction plate 53. The heat pump 51 decreases the humidity of the air sent by the fan 38 so as to be dried and blows out the dried warm wind forward the blow-out port 52. The blow-out port 52 is a blow-out port through which the dried warm wind supplied from the heat pump 51 blows to the sheet of paper after image formation which is carried by the carriage belt 24. The blow-out port 52 is provided with the wind direction plate 53 on the image forming position side. The wind direction plate 53 causes the air blowing from the blow-out port 52 so as not to flow to the image forming position. The air blowing from the blow-out port 52 is sprayed on the paper surface, is then taken in the suction space 25a inside the carriage housing 25, and is supplied again to the heat pump 51 via the duct 37. The drying mechanism dries the sheet of paper having the image formed thereon by the dried warm wind generated by the heat pump 51 as the air is circulated as described above.

Next, the heat pump 51 will be described.

The heat pump 51 has a compressor 61, a heat exchanger 62 for heating, a heat exchanger 63 for cooling, an expansion valve 64, and fans 65 and 66. The compressor 61 compresses a cooling medium. The compressor 61 supplies the compressed high-pressure and high-temperature cooling medium to the heat exchanger 62 for heating. The heat exchanger 62 for heating transfers heat energy to the air from the high-pressure and high-temperature cooling medium supplied from the compressor 61. In addition, the heat exchanger 62 for heating transfers heat energy to the low-temperature air dehumidified (dried) by the heat exchanger 63 for cooling that will be described later so as to obtain a high temperature. Accordingly, the heat exchanger 62 for heating generates the high-temperature and dried air. The heat exchanger 62 for heating discharges the high-temperature and dried air to the blow-out port 52 by the fan 66.

The blow-out port 52 blows the high-temperature and dried air from the heat exchanger 62 for heating to a drying position E2 on the carriage belt 24. The air blowing from the blow-out port 52 evaporates moisture from the sheet of paper carried to the drying position E2 so as to fix ink onto the sheet of paper. Since the air blowing from the blow-out port 52 is dry, the drying efficiency is high although the temperature of the air is low.

In addition, the blow-out port 52 may be provided so that the high-temperature and dried air from the heat exchanger 62 for heating is applied to the sheet of paper after the image formation. That is, the drying position E2 is not limited to a position above the carriage belt 24 and may be a position at which the high-temperature and dried air is applied to the sheet of paper after the image formation. For example, the drying position E2 may be a position above the paper discharge unit 26. If the drying position E2 is the position above the paper discharge unit 26, the blow-out port 52 is installed so that the high-temperature and dried air from the heat exchanger 62 for heating is blown to the paper discharge unit 26.

The air blowing from the blow-out port 52 (the air supplied from the heat exchanger 62 for heating) is applied to the paper surface. The air applied to the paper surface takes moisture from the paper surface and becomes humid air. The air on the carriage belt 24 which includes humid air that takes moisture from the paper surface is taken in the suction space 25a through the holes 24a and the holes 33a by the fan 36 and is then discharged to the duct 37. The fan 38 sends the air discharged to the duct 37 toward the heat exchanger 63 for cooling.

In addition, the expansion valve 64 decompresses the cooling medium after transferring heat energy to the air at the heat exchanger 62 for heating and flows the decompressed cooling medium to the heat exchanger 63 for cooling. The heat exchanger 63 for cooling takes heat energy from the air using the cooling medium which has a low temperature and a low pressure by the expansion valve 64. The air from which heat energy is taken by the low-temperature and low-pressure cooling medium is cooled such that the steam (a part of moisture contained in the air) becomes water.

That is, the heat exchanger 63 for cooling cools the air using the low-temperature and low-pressure cooling medium and dries the air. The heat exchanger 63 for cooling discharges the low-temperature and dried air. The fan 65 sends the low-temperature and dried air discharged from the heat exchanger 63 for cooling to the heat exchanger 62 for heating via a duct 67. The dried air is supplied to the heat exchanger 62 for heating from the heat exchanger 63 for cooling. As a result, the heat exchanger 62 for heating heats the dried air, and thus discharges the high-temperature and dried air.

The temperature of the air (the air blowing from the blow-out port 52) supplied from the heat exchanger 62 for heating is higher than a temperature outside the image forming apparatus and is equal to or less than a temperature so as not to damage paper (for example, 40° C. to 100° C.). In addition, the humidity of the air supplied from the heat exchanger 62 for heating (the air blowing from the blow-out port 52) is lower than a humidity outside the image forming apparatus and is equal to or less than a humidity at which the drying of the ink on the paper surface can be accelerated (for example, 10% to 50%).

For example, the air supplied from the heat exchanger 62 for heating (the air blowing from the blow-out port 52) is a dried warm wind at about 70 degrees. In general heater-type drying apparatuses, a warm wind at 100 degrees or higher is applied to a sheet of paper so as to dry ink. There is a high possibility that shrinkage, curling, and wrinkles may occur in paper to which a warm wind at 100 degrees or higher is applied as the paper surface is dried.

In the image forming apparatus, since the heat pump 51 applies the dried air to the sheet of paper, the same or higher drying efficiency than the heater-type drying apparatuses can be obtained even though the temperature of the air is suppressed to be low. As a result, the image forming apparatus suppresses the temperature of the air applied to the sheet of paper to dry ink to be low, so that shrinkage, curling, and wrinkles of the sheet of paper as the image forming medium can be suppressed.

In addition, the heat pump 51 may supply the low-temperature and dried air sent from the heat exchanger 63 for cooling to a site that needs cooling. In the example of the configuration illustrated in FIG. 1, the heat pump 51 sends a part of the low-temperature and dried air sent from the heat exchanger 63 for cooling to the head portion 40, the system controller 3, and the scanner 1 via the duct 67 as well as sending the air low-temperature and dried air sent from the heat exchanger 63 for cooling to the heat exchanger 62 for heating.

For example, the low-temperature and dried air from the heat exchanger 63 for cooling may be applied to the recording head 41 of the head portion 40. Accordingly, the recording head 41 is cooled. Here, as illustrated in FIGS. 4 and 5, in the head portion 40, the gap between the recording heads 41 and the base 42 is blocked by the windbreak member 43. Accordingly, the low-temperature and dried air is not applied to the discharge hole of ink of each recording head 41 from the heat exchanger 63 for cooling. That is, the windbreak member 43 prevents the discharge hole of ink of each recording head 41 from being dried by the low-temperature and dried air from the heat exchanger 63 for cooling.

In addition, the system controller 3 has a processor, a memory, various drive circuits, various interfaces, and the like. For example, the processor such as a CPU may need cooling. If the low-temperature air from the heat exchanger 63 for cooling is applied to the processor, the processor can be effectively cooled. In addition, if the low-temperature air from the heat exchanger 63 for cooling is applied to the memory, the drive circuits, and the like, they can also be effectively cooled. In addition, the scanner 1 has a motor drive circuit, a control board, or the like. If the low-temperature air from the heat exchanger 63 for cooling is applied to such components, they can also be effectively cooled.

In general, the heat pump has higher heat exchange efficiency than that of general heaters for heating. For example, the heat pump has a value of 3 to 5 in terms of COP (Coefficient of Performance). In a heat pump that has a COP of about 3 to 5, it is possible to transfer heat energy of about 1,500 W using a compressor of 500 W. As described above, the image forming apparatus in which there are a part to be dried and a part to be cooled can enhance energy efficiency using the heat pump.

Next, the configuration of a control system of the image forming apparatus will be described.

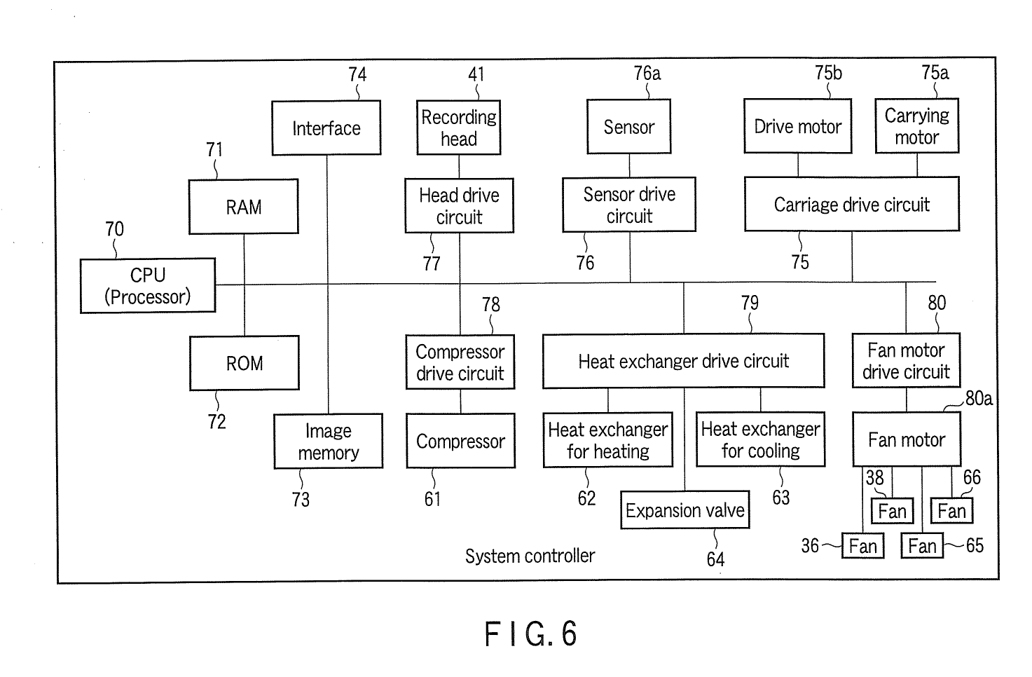

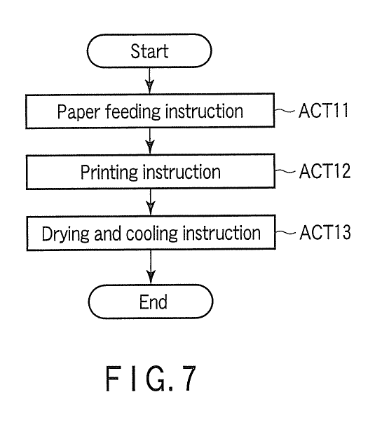

FIG. 6 is a block diagram for explaining an example of the configuration of the control system of the image forming apparatus.

The system controller 3 has a CPU 70 as the processor for controlling the overall image forming apparatus. The CPU 70 is connected to a RAM 71, a ROM 72, an image memory 73, an interface 74, a sensor drive circuit 76, a carriage drive circuit 75, a head drive circuit 77, a compressor drive circuit 78, a heat exchanger drive circuit 79, and a fan motor drive circuit 80.

The CPU 70 executes programs stored in the ROM 72 or the like using the RAM 71. The CPU 70 outputs a control signal for controlling each unit according to control programs. In addition, the CPU 70 is connected to a display unit that displays a guide for a user, an operation panel to which an operation instruction is input by the user, the scanner 1, and the like. The RAM 71 functions as a working memory. The ROM 72 is a non-volatile memory that stores the control programs and control data. The image memory 73 is a memory that stores image data. The image memory 73 is, for example, a page memory or a hard disk drive.

The interface 74 is an interface for connection to an external device. For example, the interface 74 is a network interface or the like for connection to an external device via a network. In addition, the interface 74 may also be an external storage device or an interface for local connection to a memory card. The scanner 1 may be connected via the interface 74.

The carriage drive circuit 75 is a circuit that drives the carrying mechanism. For example, the carriage drive circuit 75 drives a drive motor 75b that rotates the drive roller 31 and a carrying motor 75a that drives the carrying mechanism such as the paper feed roller 22. The carriage drive circuit 75 drives the drive motor 75b depending on a drive command from the CPU 70. For example, the CPU 70 drives a drive unit 30 so that the sheet of paper is carried to the image forming position at a timing determined based on a sensing result of a sensor.

The sensor drive circuit 76 drives a sensor 76a provided in each unit of the image forming apparatus. The sensor drive circuit 76 outputs the sensing result of the sensor 76a to the CPU 70. The sensor 76a is, for example, a sensor that senses a sheet of paper as an image forming medium carried by the carrying mechanism. The CPU 70 controls each unit according to the sensing result of the sensor 76a provided in each unit of the image forming apparatus. For example, the CPU 70 determines a timing to carry the sheet of paper to the image forming position according to the sensing result of the sensor provided in front of the image forming position.

The head drive circuit 77 drives each of the recording heads 41 provided in the head portion 40. The head drive circuit 77 drives the recording heads 41 according to the drive command from the CPU 70. For example, the head drive circuit 77 drives each of the recording heads 41 according to the image data received from the CPU 70 and information on carriage timings of the sheets of paper.

The compressor drive circuit 78 drives the compressor 61. The compressor 61 compresses the cooling medium in the heat pump 51. The heat exchanger drive circuit 79 drives the heat exchanger 62 for heating and the heat exchanger 63 for cooling. The heat exchanger 62 for heating heats the air using the cooling medium compressed by the compressor 61. The heat exchanger 63 for cooling cools the air using the decompressed cooling medium. That is, the CPU 70 drives the heat pump 51 using the compressor drive circuit 78 and the heat exchanger drive circuit 79.

The fan motor drive circuit 80 drives a fan motor 80a. The fan motor drive circuit 80 drives the fan motor that rotates a fan. The fan motor drive circuit 80 drives the fan motor that rotates the fan according to the drive command from the CPU 70. That is, the CPU 70 controls the flow of air inside the image forming apparatus by rotating fans in each unit using the fan motor drive circuit 80.

Next, the workflow of an image forming process performed in the image forming apparatus will be described.

The CPU 70 instructs a sheet of paper to be fed and carried at a request of a user for the image forming process (ACT 11). If the request of the user for the image forming process is received, the CPU 70 feeds the sheet of paper as the image forming medium from the cassette 21. The CPU 70 carries the sheet of paper fed from the cassette 21 to the carriage belt 24. The CPU 70 determines a timing of image formation on the basis of the sensing result of the sensor 76a or the like. The CPU 70 drives the drive roller 31 according to the timing of image formation. The carriage belt 24 driven by the drive roller 31 carries the sheet of paper to the image forming position at the timing determined by the CPU 70.

The CPU 70 instructs printing according to a carried status of the sheet of paper (ACT 12). That is, the CPU 70 controls each of the recording heads 41 to be driven according to the image data at the timing at which the sheet of paper is carried to the image forming position. Each of the recording heads 41 discharges ink under the drive control according to the image data, thereby forming an image on the sheet of paper. At the image forming position, the image is formed on the sheet of paper by the ink discharged from the recording heads 41.

In addition, the CPU 70 that receives the request of the user for the image forming process instructs drying and cooling using the heat pump 51 (ACT 13). The CPU 70 controls the blow-out port 52 to blow out dried warm wind until the sheet of paper on which the image is formed is carried to the drying position. The CPU 70 drives the compressor 61 using the compressor drive circuit 78. The compressor 61 driven by the compressor drive circuit 78 supplies the cooling medium that is compressed and thus has a high pressure and a high temperature to the heat exchanger 62 for heating. The CPU 70 drives the heat exchanger 62 for heating to which the high-pressure and high-temperature cooling medium is supplied from the compressor 61 using the heat exchanger drive circuit 79. The heat exchanger 62 for heating that is driven by the heat exchanger drive circuit 79 converts the air into high-temperature and dried air using the high-pressure and high-temperature cooling medium and discharges the dried warm wind.

In addition, the CPU 70 rotates the fans 36, 38, 65, and 66 using the fan motor drive circuit 80. The dried warm wind from the heat exchanger 62 for heating (the air has a low humidity and a high temperature) is blown from the blow-out port 52 provided at the drying position by the rotation of the fan 66. That is, the CPU 70 discharges the dried warm wind generated by the heat pump from the blow-out port by controlling the fan. In addition, the air blown to the drying position on the carriage belt 24 from the blow-out port 52 (air including the air after drying the paper surface) is flowed into the suction space 25a and the duct 37 by the rotations of the fans 36 and 38 and is then supplied to the heat exchanger 63 for cooling of the heat pump 51 again.

In addition, in the heat pump 51, the high-pressure and high-temperature cooling medium which heats the air at the heat exchanger 62 for heating is decompressed and supplied to the heat exchanger 63 for cooling from the expansion valve 64. The CPU 70 drives the heat exchanger 63 for cooling to which the decompressed cooling medium is supplied using the heat exchanger drive circuit 79. The heat exchanger 63 for cooling that is driven by the heat exchanger drive circuit 79 cools the air using the cooling medium which is decompressed and thus has a low temperature and a low pressure and discharges the low-temperature and dried air (dried cold wind).

The dried cold wind from the heat exchanger 63 for cooling is supplied to the heat exchanger 62 for heating by the rotation of the fan 65. The heat exchanger 62 for heating may generate the dried warm wind in order to warm up the dried cold wind. In addition, the dried cold wind from the heat exchanger 63 for cooling is supplied not only to the heat exchanger 62 for heating but also to a site that needs cooling. For example, a part of the dried cold wind from the heat exchanger 63 for cooling is supplied to the recording heads 41, the system controller 3, and the scanner 1 via the duct in the heat pump. The recording head 41, the system controller 3, and the scanner 1 are cooled by the dried cold wind.

The image forming apparatus according to this embodiment has the heat pump as described above. The heat pump of the image forming apparatus generates air which has a low humidity and a high temperature. The image forming apparatus causes the air which is generated by the heat pump and has a low humidity and a high temperature to be applied to the medium after the image formation. In the image forming apparatus, since the air applied to the medium has a low humidity and is dry, the efficiency in drying the ink on the medium is high, thereby accelerating the drying of the ink.

In addition, the heat pump generates dried air which has a low humidity. Accordingly, the image forming apparatus can obtain high drying performance although the air does not have a high temperature at which there is a possibility that the image forming medium such as paper may be damaged. That is, the image forming apparatus can suppress the temperature of the air for drying the sheet of paper having the image formed thereon to be low, so that damage such as wrinkles, curling, and shrinkage cannot occur in the sheet of paper as the image forming medium.

In addition, the heat pump cools the air in order to lower the humidity of the air. The image forming apparatus supplies a part of the cooled air that is obtained in an operation of generating low-humidity air by the heat pump to the site (the CPU that controls a machine, the recording head, or the scanner) that needs cooling inside the apparatus. The image forming apparatus may cool the site that needs cooling, such as, the CPU, the recording head, or the scanner using the low-temperature air generated by the heat pump. In addition, the heat pump of the image forming apparatus can generate the warm wind for drying and the cold wind for cooling with low power consumption, so that energy saving efficiency is high.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit which forms an image on a medium;
a heat pump which generates air of a decreased low humidity; and
a blow-out port which blows the low-humidity air generated by the heat pump to the medium on which the image is formed by the image forming unit.

2. The image forming apparatus according to claim 1, wherein the image forming unit includes a recording head that forms the image on the medium with ink.

3. The image forming apparatus according to claim 2, wherein the heat pump includes a compressor and a heat exchanger for cooling.

4. The image forming apparatus according to claim 3, further comprising a carriage housing which has a space therein at a position opposed to the blow-out port.

5. The image forming apparatus according to claim 4, further comprising a duct which is connected to the carriage housing and the heat pump.

6. The image forming apparatus according to claim 3, wherein the heat exchanger for cooling dries the air using a cooling medium.

7. The image forming apparatus according to claim 6, wherein the humidity of the air generated by the heat pump is lower than a humidity outside the apparatus.

8. The image forming apparatus according to claim 3, wherein the heat pump includes a heat exchanger for heating.

9. The image forming apparatus according to claim 8, wherein the heat exchanger for heating transfers heat energy from the cooling medium supplied from the compressor to the air.

10. The image forming apparatus according to claim 9, wherein a temperature of the air generated by the heat pump is higher than a temperature outside the apparatus.

11. The image forming apparatus according to claim 9, wherein the heat pump supplies cooled low-temperature air to a site that needs cooling inside the image forming apparatus.

12. The image forming apparatus according to claim 11, wherein the site that needs cooling is a processor for system control.

13. The image forming apparatus according to claim 11, wherein the site that needs cooling is the recording head.

14. The image forming apparatus according to claim 11, further comprising a scanner which converts an image of an original document into image data,
wherein the heat pump supplies the cooled low-temperature air to the scanner.

15. The image forming apparatus according to claim 3, further comprising a wind direction plate which sets up on the image forming unit side of the blow-out port.

16. A drying method used in an image forming apparatus, comprising:
forming an image on a medium;
generating air of which a humidity is decreased; and
blowing the generated air to the medium on which the image is formed.

17. The method according to claim 16, wherein the image is formed on the medium with ink.

18. The method according to claim 17, wherein the humidity-lowered air is generated by cooling air using a cooling medium.

19. The method according to claim 18, further comprising heating the humidity-decreased air.
